(19) United States
(12) Patent Application Publication
(10) Pub. No.: US 2008/0186528 A1
(43) Pub. Date: Aug. 7, 2008

(54) METHOD AND APPARATUS FOR PRINT STATISTICS REPORTING

(75) Inventors: Michael Gregory Doose, San Diego, CA (US); John M. Williams, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/670,026

(22) Filed: Feb. 1, 2007

(51) Int. Cl. G06F 3/12

(52) U.S. Cl. 358/1.15

(57) ABSTRACT

Embodiments disclosed herein relate to compiling and reporting printing statistics in a printing system. In an embodiment, a data gathering unit may be configured to query print servers for print events (e.g., occurring in a period of time); parse each print event according to a set of attributes (e.g., user ID, time, print volume, document name, printer ID, etc.); and output each parsed print event to a storage medium (e.g., a database). The data gathering unit may be further linked to a user database (e.g., an employee directory in an enterprise-type system), and configured to associate each print event with one or more extended attributes (e.g., employee name, department name, location, etc.). An interface unit may be configured to provide for customized query and report based on the print events stored in the storage medium.

### BACKGROUND

1. Field

This disclosure relates generally to printers and printing systems. More specifically, embodiments disclosed herein relate to monitoring printing usage, compiling and reporting printing statistics in a printing system.

2. Background

In printing systems employing multiple printers at various locations (such as in an enterprise-type environment), there generally lacks information such as current and historical printing usage statistics (e.g., on a per-printer, per-location, and/or per-department basis). As a result, printing device selection and allocation of such devices in an organization (or enterprise) are typically by way of guessing or crude estimate at best. This has caused inefficiency, loss of productivity, and waste of system resources. Furthermore, printing device vendors and service providers desire to provide accurate printing assessments for their customers (e.g., based on printing usage statistics of the customers), so that appropriate contract types and terms can be drafted and easily evaluated, printing device selection may be based on print volume per device, printer saturation may be adjusted based on use, and so on.

In view of the foregoing, there exists a need to actively monitor printing usage, compiling and reporting printing statistics in a printing system.

### BRIEF DESCRIPTION OF THE DRAWINGS

FIG. 1 illustrates an embodiment of a system, in which various disclosed embodiments may be implemented;

FIG. 2 illustrates a flow diagram of a process, which may be used in an embodiment to compile and report printing statistics; and

FIG. 3 illustrates a block diagram of an apparatus, which may be used to implement some disclosed embodiments.

### DETAILED DESCRIPTION

Embodiments disclosed herein relate to compiling and reporting printing statistics in a printing system.

A “printing system” used herein may generally refer to a system having one or more printers (or printing devices), which may be connected to one or more print servers and distributed at one or more locations. A “print server” used herein may generally refer to any server configured to run printing services.

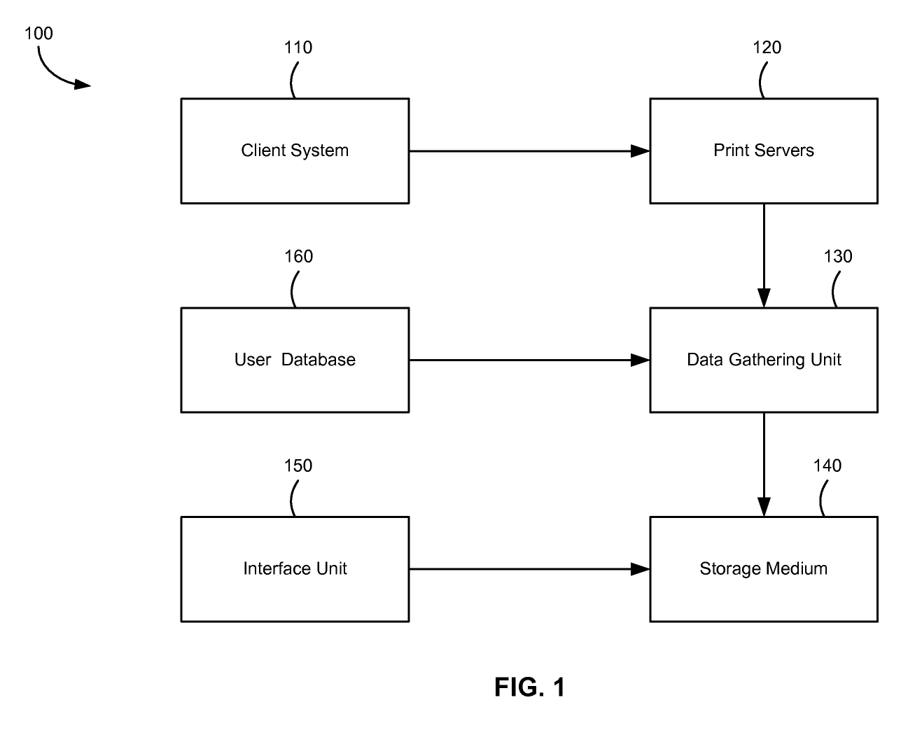

FIG. 1 illustrates an embodiment of a system, in which various disclosed embodiments and aspects may be implemented, as further described below. By way of example, system 100 may include a client system 110 (which may include one or more user computers, servers, etc., such as in an enterprise-type system); one or more print servers (along with associated printers) 120; a data gathering unit (or module) 130; and a storage medium (e.g., a database) 140. System 100 may further include an interface unit (or module) 150, which may be a Web-based interface configured to provide for customized query and report. In some embodiments, data gathering unit 130 may also be linked to a user database 160 (e.g., an employee directory in an enterprise-type system), as further described below.

In an embodiment, client system 110 may send print requests to print servers 120, which may in turn instruct associated printers to perform the requested print jobs. Print servers 120 may each maintain a log of print events (or “print event data”), wherein each print event may include information such as the user identifier (ID) associated with a particular print job, the name of the printed document, the number of pages printed, the time at which the print job takes place (or time duration of the print job), the printer ID (which may be indicative of the location and/or model of the printer performing the print job), etc.

Data gathering unit 130 may be configured to query print servers 120 for print events taking place during a specified period of time (e.g., 24 hours), and parse each print event thus obtained according to a set of attributes/fields (e.g., user ID, time, print volume, document name, printer ID, and other attributes deemed as relevant). Data gathering unit 130 may be further configured to output the parsed print event data to database 140. There may be situations where the printer ID contained in a print event does not include the associated printer model. In such cases, data gathering unit 130 may additionally query print servers 120 for the printer model associated with each print event, and include the print model in the print event data output to database 140.

In some embodiments, data gathering unit 130 may also be configured to associate with each print event with one or more extended attributes, e.g., by making use of information in user database 160. The extended attributes may include, for example, employee name (or number), department name (or number), location, and other relevant attributes. In this way, data gathering unit 130 may further determine printing usage, e.g., on a per-department basis, per-employee basis, per-location basis, etc. This may also allow for monitoring and tracking of documents printed in the system, which may be useful in an enterprise-type environment (e.g., for security, document control, and other purposes).

Interface unit 150 may be configured to provide for customized query and report functionalities, based on the print event data stored in database 140 (such as described above). For example, an entity (e.g., the Information Technology (IT) administration in an enterprise-type system) may run various queries regarding printing usage (e.g., print volume associated with one or more printers during a period of time, print volume associated with one or more departments or locations, etc.), analyze the query results, compile and report printing statistics accordingly. Interface unit 150 may also be configured to compile and report printing statistics on a regular basis (e.g., daily or weekly), e.g., by automatically running a set of queries on the print event data stored in database 140.

By way of example in the embodiment of FIG. 1, interface unit 150 is shown as one entity (e.g., a Web-based interface residing on a Web server), providing both customized query and report functionalities. In other embodiments, such query and report functionalities may be implemented in separate interface units.

In some embodiments, data gathering unit 130 and database 140 may be collocated, e.g., residing on a common storage medium (such as a server). In other embodiments, data gathering unit 130, database 140, and interface unit 150 may be collocated, e.g., residing on a common server.

System 100 may be implemented in any system employing one or more printers, such as an organization (or enterprise), a division of an organization, etc.

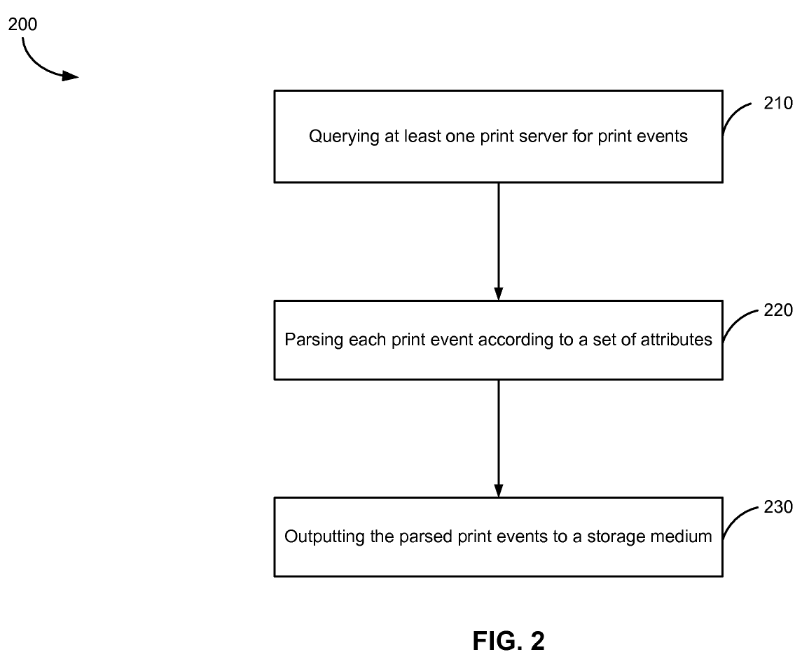

FIG. 2 illustrates a flow diagram of a process 200, which may be used in an embodiment to compile and report printing statistics (such as described above). Step 210 queries at least one print server for print events (e.g., occurring in a period of time). Step 220 parses each print event according to a set of attributes (e.g., user ID, time, document name, print volume, printer model, etc.). Step 230 outputs the parsed print event data to a storage medium (e.g., a database). Process 200 may further include associating each print event with one or more extended attributes (e.g., employee name, department name/number, location, and other relevant attributes associated with each print event).

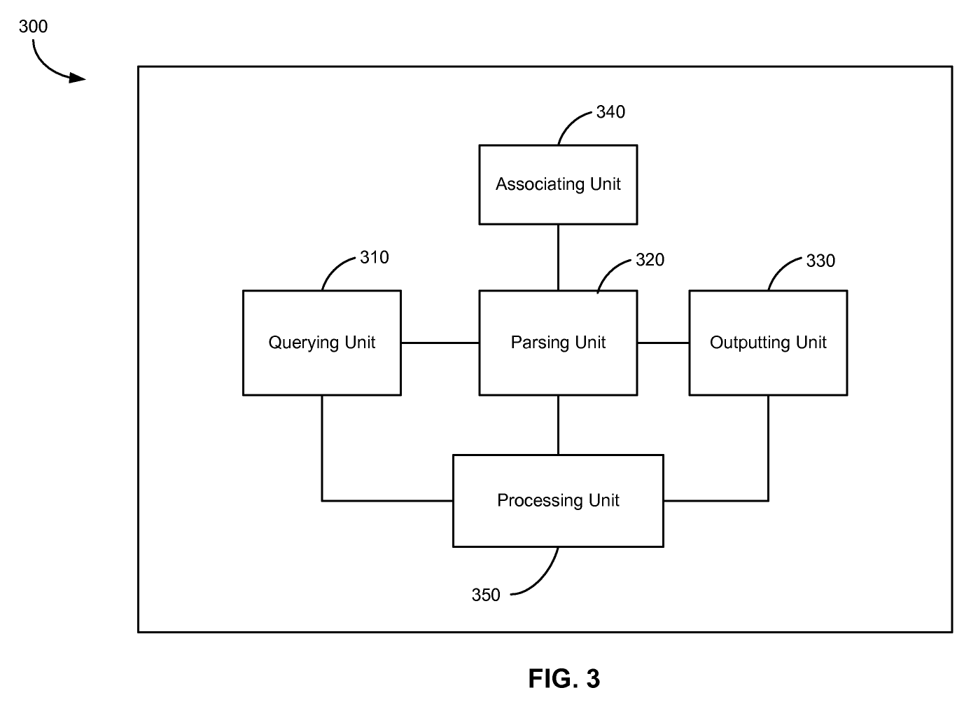

FIG. 3 illustrates a block diagram of an apparatus 300, which may be used in an embodiment to implement a data gathering unit (such as described above). By way of example, apparatus 300 may include a querying unit (or module) 310 configured to query at least one print server for print events (e.g., occurring in a period of time); a parsing unit 320 configured to parse each print event according a set of attributes (such as described above); and an outputting unit 330 configured to output the parsed print event data to a storage medium. Apparatus 300 may further include an associating unit 340 configured to associate each print event with one or more extended attributes (such as described above). Apparatus 300 may also include a processing unit (or controller) 350, configured to control and/or coordinate the operations of various units.

Embodiments disclosed herein provide some embodiments of compiling and reporting printing statistics in printing systems. There are other embodiments and implementations. Various embodiments allow enterprises and/or printing device vendors and service providers to create realistic printing usage models and make accurate printing assessments, thereby improving productivity and cost-effectiveness.

Various units/modules and embodiments disclosed herein may be implemented in hardware, software, firmware, or a combination thereof. In a hardware implementation, various units may be implemented within one or more application specific integrated circuits (ASICs), digital signal processors (DSPs), digital signal processing devices (DSPDs), field programmable gate arrays (FPGAs), processors, microprocessors, controllers, microcontrollers, programmable logic devices (PLDs), other electronic units, or any combination thereof. In a software implementation, various units may be implemented with modules (e.g., procedures, functions, and so on) that perform the functions described herein. The software codes may be stored in a memory unit and executed by a processor (or processing unit). The memory unit may be implemented within the processor or external to the processor, in which case it can be communicatively coupled to the processor via various means known in the art.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and the functions described in connection with various embodiments described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a computer. By way of example, and not limitation, such computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, may include compact disc (CD), laser disc, optical disc, digital versatile disc (DVD), floppy disk and blue-ray disc where disks may reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for printing systems, comprising:
querying at least one print server for print events;
parsing each print event according to a set of attributes; and
outputting each parsed print event to a storage medium.

2. The method of claim 1, wherein the set of attributes includes a plurality of a user identifier (ID), a time, a print volume, a document name, and a printer ID associated with each print event.

3. The method of claim 2, further comprising associating each print event with at least one extended attribute.

4. The method of claim 3, wherein the at least one extended attribute includes at least one of an employee name, a department name, and a location.

5. A computer program product, comprising:
code for causing a computer to query at least one print server for print events;
code for causing a computer to parse each print event according to a set of attributes; and
code for causing a computer to output each parsed print event to a storage medium.

6. The computer program product of claim 5, wherein the set of attributes includes a plurality of a user ID, a time, a print volume, a document name, and a printer ID associated with each print event.

7. The computer program product of claim 6, further comprising code for causing a computer to associate each print event with at least one extended attribute.

8. The computer program product of claim 7, wherein the at least extended attribute includes at least one of an employee name, a department name, and a location.

9. The computer program product of claim 7, further comprising code for causing a computer to provide for customized query and report based on the print events stored in the storage medium.

10. An apparatus adapted for printing systems, comprising:
means for querying at least one print server for print events;
means for parsing each print event according to a set of attributes; and
means for outputting each parsed print event to a storage medium.

11. The apparatus of claim 10, wherein the set of attributes includes a plurality of a user identifier (ID), a time, a print volume, a document name, and a printer ID associated with each print event.

12. The apparatus of claim 10, further comprising means for associating each print event with at least one extended attribute.

13. The apparatus of claim 10, further comprising the storage medium.

14. An apparatus, comprising:
a storage medium; and
a data gathering unit configured to:
query at least one print server for print events;
parse each print event according to a set of attributes; and
output each parsed print event to the storage medium.

15. The apparatus of claim 14, further comprising an interface unit, configured to provide for customized query and report based on the print events stored in the storage medium.

16. The apparatus of claim 14, further comprising an associating unit configured to associate each print event with at least one extended attribute.
